(19) United States
(12) Patent Application Publication
(10) Pub. No.: US 2009/0248257 A1
(43) Pub. Date: Oct. 1, 2009

(54) SEAT DEVICE FOR VEHICLE

(75) Inventors: Yoko Hoshino, Hiroshima-city (JP); Hiroki Uemura, Hiroshima-city (JP); Yoshihisa Okamoto, Hiroshima-city (JP); Tadayuki Niibe, Hiroshima-city (JP); Yusaku Takeda, Aki-gun (JP)

Correspondence Address: Studebaker & Brackett PC, 1890 Preston White Drive, Suite 105, Reston, VA, 20191, US

(73) Assignee: MAZDA MOTOR CORPORATION, Hiroshima (JP)

(21) Appl. No.: 12/395,644

(22) Filed: Feb. 28, 2009

(30) Foreign Application Priority Data
Mar. 31, 2008 (JP) 2008-091448

(51) Int. Cl. G06F 17/00; G08B 23/00

(52) U.S. Cl. 701/49; 340/573.1

(57) ABSTRACT

An egress-start determining device determines a start of egress of a passenger seated in a seat of a vehicle. A completion determining device determines completion of a driver's head moving out of a door opening of the vehicle after the start of egress of the passenger. A seat-sitting-face height adjusting device adjusts a height of a sitting face of the seat in such a manner that the height is adjusted to a first height during a time from the start of egress of the passenger to the completion of the driver's head moving out of the door opening of the vehicle, and the height is adjusted to a second height after the completion of the driver's head moving out of the door opening of the vehicle.

### BACKGROUND OF THE INVENTION

The present invention relates to a seat device which is applicable to a vehicle, such as an automotive vehicle, and in particular, relates to a seat device for a vehicle which can improve the egress of a passenger seated in a seat.

A passenger seated in a seat of the vehicle generally tries to egress, paying attention to a vehicle roof or an upper edge of a door opening so as not to hit a passenger's head against them, and also paying attention to a tire house so as to avoid improper interference of a passenger's hip with it in case the passenger is seated in a rear seat. Thus, the passenger may be burdened with these paying attentions.

Accordingly, various seat devices for a vehicle have been proposed for the purpose of providing a smooth egress of the passenger by improving the egress of the passenger. Japanese Patent Laid-Open Publication No. 2007-185988, for example, discloses a seat device in which a reclining angle of a seat back relative to a seat cushion is adjusted to an appropriate angle for the egress of the passenger when the passenger's egress is determined based on some information, such as an unlock of a door lock, an opening of the door, or a buckle release of a seatbelt device.

Herein, the vehicle-egress move of the passenger is comprised of various specific actions of body's parts. Therefore, only the adjustment of the reclining angle of the seat back may not be enough to reduce the above-described burden to the passenger effectively

### SUMMARY OF THE INVENTION

An object of the present invention is to provide a seat device for a vehicle which can effectively reduce the burden to the passenger when the passenger egresses from the vehicle.

According to the present invention, there is provided a seat device for a vehicle, comprising an egress-start determining device to determine a start of egress of a passenger seated in a seat of the vehicle, a completion determining device to determine completion of a driver's head moving out of a door opening of the vehicle after the start of egress of the passenger, and a seat-sitting-face height adjusting device to adjust a height of a sitting face of the seat in such a manner that the height is adjusted to a first height during a time from the start of egress of the passenger to the completion of the driver's head moving out of the door opening of the vehicle, and the height is adjusted to a second height after the completion of the driver's head moving out of the door opening of the vehicle.

According to the present invention, since the height of the seat sitting face is properly adjusted respectively before and after the driver's head moves out of the door opening during the egress move of the passenger in accordance with a change of the burden to an upper half of a passenger's body and a lower half of the passenger, the above-described burden to the passenger at the passenger's egress can be reduced effectively.

According to an embodiment of the present invention, the seat device for a vehicle further comprises a body-size detecting device to detect a body size of the passenger, wherein the first height is set based on a length of an upper half of a passenger's body which influence a burned to the upper half of a passenger's body and the second height is set based on a length of a lower half of the passenger's body which influences the upper half of the passenger's body. Thereby, the first and second heights are set respectively based on the length of the upper half and the lower half of the passenger's body which influence the burdens to the passenger at the passenger's egress. Accordingly, before the passenger's head moving out of the vehicle, the burden to upper half of the passenger's body can be reduced properly, ensuring an enough head clearance. Then, after the passenger's head moving out of the vehicle, the muscle of the lower half of the passenger's body is assisted in taking a standing position, so that the muscle burden to lower half of the passenger's body can be reduced properly.

According to another embodiment of the present invention, the seat device for a vehicle further comprises a door-opening angle detecting device to detect an opening angle of a door, wherein at least one of the first height and second height is corrected by the opening angle of the door which is detected by the door-opening angle detecting device. Thereby, the reduction of the burden to the passenger can be conducted properly considering that the gravity center of the passenger's body at the passenger's egress changes in accordance with the opening angle of the door.

According to another embodiment of the present invention, the vehicle is a type of vehicle in which an upper edge of a door opening of a rear side door becomes shorter gradually along a rearward direction of the vehicle, the seat-sitting-face height adjusting device is applied to a rear seat which is provided beside the rear side door, and at least one of the first height and second height is corrected by the opening angle of the rear side door which is detected by the door-opening angle detecting device in such a manner that the height corrected becomes lower when the opening angle of the rear side door is relatively small. Thereby, even in case the opening angle of the rear side door is so small that the gravity center of the passenger's body moves rearward and the passenger needs to egress through an area in which the upper edge of the door opening becomes relatively low, the height of the sitting face of the rear seat is lowered correctively, so that the passenger's head can be properly passed below the upper edge of the door opening with little burden to the passenger.

According to another embodiment of the present invention, the seat is a rear seat of the vehicle, and the second height is greater than a tire house which is provided substantially beside the rear seat. Thereby, the burden to the passenger at the passenger's egress can be reduced effectively, avoiding improper interference of the passenger's hip with the tire house.

According to another embodiment of the present invention, the completion determining device comprises an image picking-up device which is provided at a door mirror of the vehicle. Further, the body-size detecting device comprises an image picking-up device which is provided at a door mirror of the vehicle. Thereby, the position of the passenger's head or the body size of the passenger can be detected by the image picking-up device easily and precisely.

According to another embodiment of the present invention, the above-described second height is greater than the above-described first height. Thereby, the burden to the passenger at the passenger's egress can be properly reduced effectively.

Other features, aspects, and advantages of the present invention will become apparent from the following description which refers to the accompanying drawings.

### BRIEF DESCRIPTION OF THE DRAWINGS

FIG. 1 is a schematic side view of an inside of a vehicle compartment of an automotive vehicle which is equipped with a seat device according to an embodiment of the present invention.

FIG. 2 is an explanatory diagram showing an example of a seat-sitting-face height adjusting device which is provided at the seat device.

FIG. 3 is a block diagram schematically showing constitution of a seat control unit of the seat device.

FIG. 4 is a flowchart explaining an operation control of a seat at a passenger's egress.

FIG. 5A is an elevation view schematically showing position relationships between a seat and surrounding portions of a vehicle, and FIG. 5B is a side view schematically showing the position relationships.

FIG. 6 is an explanatory diagram showing lengths of upper and lower halves of a body of a passenger seated in the seat.

FIGS. 7A through 7D are explanatory diagrams schematically showing a sequence of an egress move of the passenger seated in the seat.

### DETAILED DESCRIPTION OF THE INVENTION

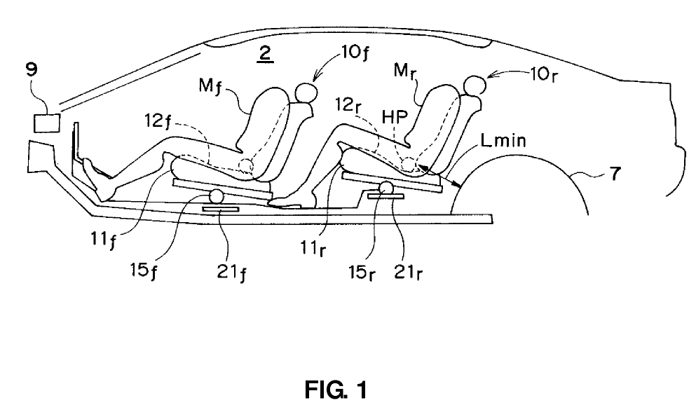

Hereinafter, a preferred embodiment of the present invention will be described referring to the accompanying drawings. FIG. 1 is a schematic side view of an inside of a vehicle compartment of an automotive vehicle which is equipped with a seat device according to the present embodiment. As shown in the figure, two rows of seats 10f, 10r are provided inside a vehicle compartment 2 of the automotive vehicle, and seat-sitting-face height adjusting devices 15f, 15r to adjust heights of seat sitting faces 12f, 12r (sitting faces of seat cushions 11f, 11r) and seat vertical-position sensors 21f, 21r to detect the heights (vertical positions) of seat sitting faces 12f, 12r are provided at a bottom face of the seat cushions 11f, 11r of the seats 10f, 10r.

The present automotive vehicle is a type of vehicle in which an upper edge of a door opening becomes shorter gradually along a rearward direction of the vehicle. Accordingly, in case an opening angle of the door is small, the gravity center of a body of a passenger Mr seated in the rear seat 10r may move rearward and therefore need to egress through an area in which the upper edge of the door opening becomes relatively low. A tire house 7 for a rear wheel is located behind the rear seat 10r on a side portion of the vehicle.

A camera device 9 as an image picking-up device is installed to a door mirror of the automotive vehicle. The camera device 9, which is a so-called CCD camera, picks up a rear image and can detect body sizes and head positions of respective passengers Mf, Mr when the passengers egress easily and precisely based on data of the image picked up. An opening angle of the door can be detected based on the image data by the camera device 9 as well. Herein, the body size information of the passengers Mf, Mr may be alternatively obtained from IC cards which store such information, which the passengers Mf, Mr have. The IC cards may be inserted into a card reader to get the information stored therein.

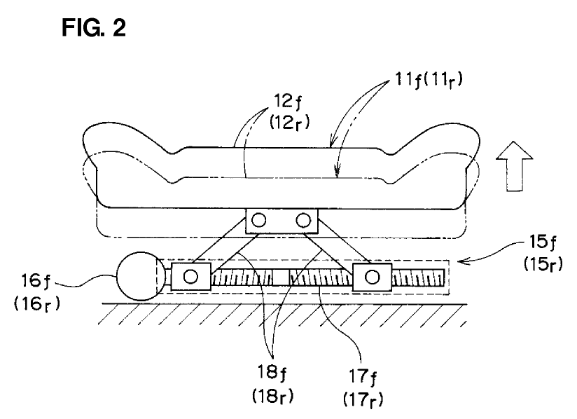

Any conventional device may be applied as the above-described seat-sitting-face height adjusting devices 15f, 15r. Such a device, for example, as shown in FIG. 2, comprises a screw rod 17f (17r) which is rotated by a motor with reduction mechanism 16f (16r) and a pair of links 18f (18r) which interconnects the screw rod 17f (17r) and a bottom of the seat cushion 11f (11r). The links 18f (18r) move so as to swing in accordance with the rotation of the screw rod 17f (17r), so that the seat cushion 11f (11r) moves vertically. Herein, the seat-sitting-face height adjusting devices 15f, 15r or the seat vertical-position sensors 21f, 21r which are respectively provided for the front seat and the rear seat have the same structure.

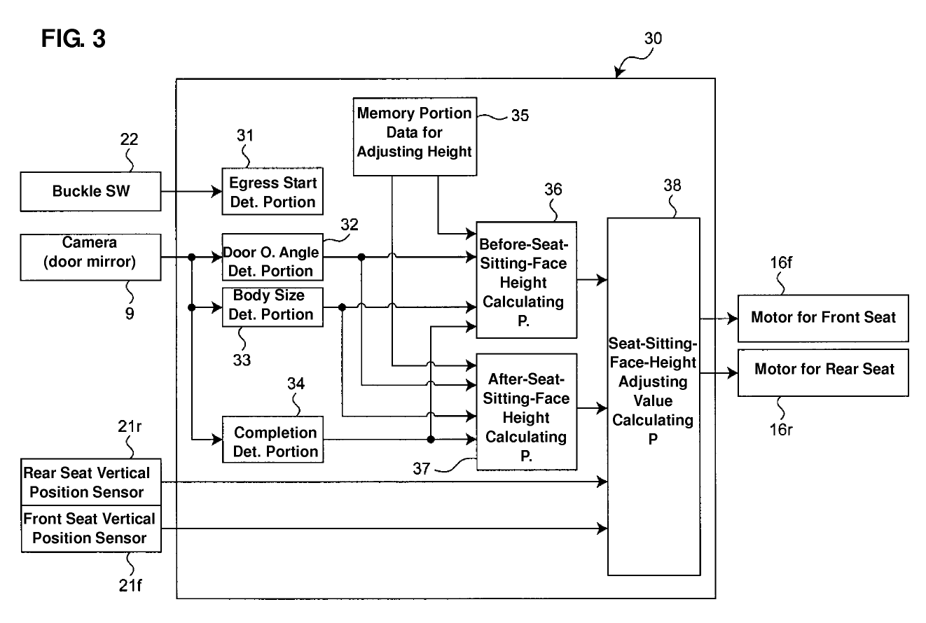

The above-described motors 16f, 16r, seat vertical-position sensors 21f, 21r, and camera device 9 are operationally coupled to a seat control unit 30 shown in FIG. 3. Further, there is provided a buckle switch 22 to detect a lock/unlock state of a buckle of a seatbelt (not illustrated) as part of an egress-start determining device to determine a start of egress of the passenger Mf (Mr). The start of egress of the passenger Mf (Mr) can be determined by detecting that the buckle has been unlocked from its lock state. The buckle SW 22 is operationally coupled to the seat control unit 30.

The seat control unit 30 controls the front seat 10f and the rear seat 10r respectively, which preferably comprises a micro computer. Herein, the seat control unit 30 may be comprised as a standalone computer or may be incorporated into another control device or a vehicle-total control unit.

The seat control unit 30 comprises an egress-start determining portion 31 to which the detecting signal of the buckle SW 22 is inputted, and a door-opening angle determining portion 32, a body-size determining portion 33 and a completion determining portion 34 to which the picked-up image data from the camera device 9 is inputted. The egress-start determining portion 31 determines based on the input signal from the buckle SW 22 whether the passengers Mf, Mr remain seated or start their egress moves of the vehicle. The door-opening angle determining portion 32 determines the opening angle of the door (full open, closed, half open, narrower or wider open than the half open) based on the picked-up image data from the camera device 9.

The body-size determining portion 33 determines the body size of the passengers Mf, Mr based on the picked-up image data from the camera device 9. The completion determining portion 34 determines whether the driver's head has moved out of the door opening of the vehicle or not (namely, whether the driver's head moving out of the door opening is completed or not) after the passengers Mf, Mr started the egress move of the vehicle.

The seat control unit 30 further comprises a memory portion 35 which stores data for adjusting the height of the sitting face which will be described. Herein, the memory portion 35 is not necessary provided in the seat control unit 30, but may be provided as an outer memory which is disposed outside the unit 30 so as to read the data from outside.

Further, the seat control unit 30 comprises a before-seat-sitting-face height calculating portion 36 to calculate a preferable height of the sitting face of the seat during a time from the start of the passenger's egress move to the completion of the driver's head moving out of the door opening of the vehicle. This calculation is executed, in case the start of the egress-move of the passengers Mf, Mr has been determined, based on determination results of the above-described portions 32 and 33 and with application of the data for adjusting the height of the sitting face stated in the above-described memory portion 35. Further, the seat control unit 30 comprises an after-seat-sitting-face height calculating portion 37 to calculate a preferable height of the sitting face of the seat after the completion of the driver's head moving out of the door opening of the vehicle. The calculation of the after-seat-sitting-face height calculating portion 37 is executed, in case the completion of the driver's head moving out of the door opening has been determined by the completion determining portion 34, based on determination results of the above-described portions 32 and 33 and with application of the data for adjusting the height of the sitting face stated in the above-described memory portion 35.

The seat control unit 30 comprises a seat-sitting-face-height adjusting value calculating portion 38 to calculate an adjusting value of the height of the sitting face of the seat based on the input signals from the seat vertical-position sensors 21f, 21r and the input signals from the above-described calculating portions 36, 37. The calculated adjusting value by the portion 38 is outputted as control signals to the above-described motors 16f, 16r of the seat-sitting-face height adjusting devices 15f, 15r, so that the height of the sitting face of the seat can be adjusted.

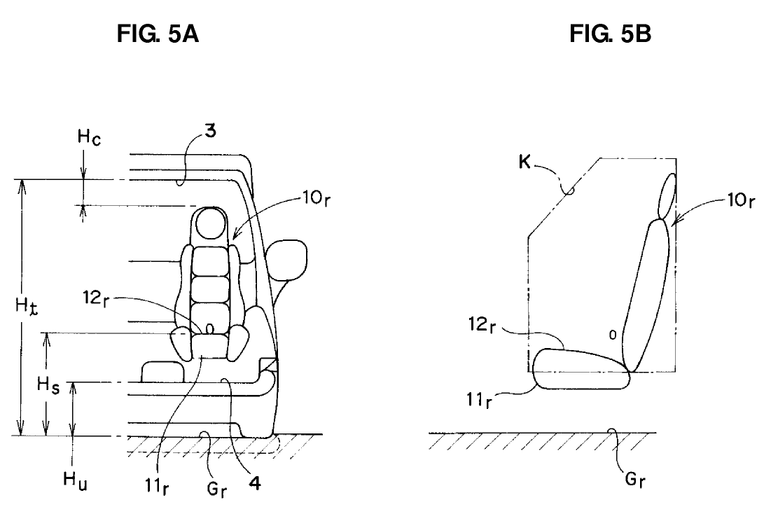

Next, the data for adjusting the height of the sitting face stated in the memory portion 35 of the seat control unit 30 and processing of the calculations of the calculating portions 36, 37 will be described as an example applied to the rear seat 10r, for example. FIGS. 5A and 5B are an elevation view and a side view schematically showing position relationships between the rear seat 10r and its surrounding portions of the vehicle. A height Ht from a grand face Gr to a ceiling face 3 of the vehicle compartment, and a height Hu from the ground face Gr to a floor face 4 of the vehicle compartment are shown. Further, a head clearance from the passenger's head to the ceiling face 3 is denoted by reference character Hc, and the height of the sitting face 12r of the seat from the ground face 3 is denoted by reference character Hs. Reference character K denotes the door opening.

When the passenger Mr seated in the seat 10r egresses from the vehicle, the passenger's position with a stoop may need to be taken in order to ensure an enough head clearance before the passenger's head moving out of the door opening K of the vehicle. Therefore, the burden to upper half of the passenger's body may be increased. Accordingly, it is preferable that the height Hs of the sitting face be lower at this moment. Meanwhile, after the passenger's head has moved out of the door opening K of the vehicle, the muscle burden to lower half of the passenger's body would become too large if the height Hs of the sitting face of the seat remained lower. Accordingly, it is preferable that the height Hs of the sitting face be higher at this moment.

According to the present embodiment, in order to improve the vehicle egress of the passenger Mr seated in the seat 10r, it is detected whether the driver's head has moved out of the door opening of the vehicle after the start of the egress move of the passenger Mr, and the seat-sitting face 12r is adjusted so as to become relatively low until the completion of the driver's head moving out of the door opening of the vehicle, so that the burden to the upper half of the passenger's body for taking the position with the stoop to ensure the enough head clearance can be reduced. Meanwhile, the seat-sitting face 12r is adjusted so as to become relatively high after the completion of the driver's head moving out of the door opening of the vehicle, so that the muscle burden can be reduced.

The above-described memory portion 35 of the seat control unit 30 stores the height Ht of the ceiling face 3 of the vehicle compartment from the ground face Gr as data for adjusting the sitting-face height and the height Hu of the floor face 4 of the vehicle compartment from the ground face Gr as data of the kind of vehicles. Further, the head clearance Hc from the passenger's head to the ceiling face 3 of the vehicle compartment is stored as a fixed value (50 mm, for example).

The memory portion 35 stores a minimum height Hmin of the seat-sitting face which can avoid the interference with the tire house 7 as both data for adjusting the sitting-face height and data of the kind of vehicles. The minimum height Hmin of the seat-sitting face 12r is the one to ensure a necessary minimum distance Lmin (see FIG. 1) between a hip point HP of the rear seat 10r and the tire house 7 which can avoid the improper interference of the passenger's hip with the tire house 7 at the vehicle egress move of the passenger.

Further, the memory portion 35 stores a corrective value in accordance with the door opening as data for adjusting sitting-face height. Herein, the correction is not necessary when the door is full open. However, since the egress move of the passenger when the door is in a middle-open state (slightly narrower than the half open, for example) may not be so easy compared to that when the door is full open, the correction of the height of the sitting face of the seat by reducing a specified value (50 mm, for example), which is obtained by the calculation, is conducted. The memory portion 35 further stores coefficients (ratios relative to the passenger's height) which calculate the length of the upper half of the passenger's body which may influence the burden to the upper half of the body and the length of the lower half of the passenger's body which may influence the burden to the lower half of the body, which will described below.

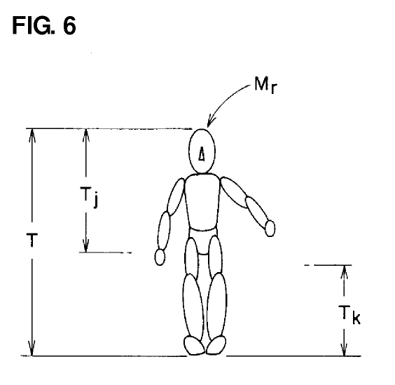

Next, processing of the before-seat-sitting-face height calculating portion 36 will be described. In case the passenger Mr with the height T (a value predicted based on the image picked up by the camera 9) shown in FIG. 6 starts the egress move and takes the position with the stoop to ensure the enough head clearance, a length Tj of the upper half of the passenger's body within a range which may take the position with the stoop without difficulty, that is, a length Tj of the upper half of the body which influences the burden to the upper half of the passenger's body is calculated using the coefficient (60%, for example) stored in the memory portion 35 (T×60%). Herein, the above-described range taking the position with the stoop without difficulty is the one in which a value which is obtained by multiplication of a torque applied to a joint of the neck and a torque applied to a joint of the waist on a locus of the driver's head moving out of the door opening through a simulation becomes the minimum.

Then, a head clearance Hc (fixed value: 50 mm, for example) of the passenger's head to the ceiling face 3 of the vehicle compartment is added to the above-described length Tj of the upper half of the body which influences the burden to the upper half of the passenger's body, and this obtained value with addition is used to calculate the height Hs of the seat's sitting face. Further, this calculated height Hs is reduced by the corrective value corresponding to the angle of the door opening, so that the preferable height H1 of the seat's sitting face for the egress move of the passenger before the driver's head moving out of the door opening is obtained finally.

Processing of the after-seat-sitting-face height calculating portion 37 will be described as follows. At first, the length of the lower half of the passenger's body is obtained from the height data T of the passenger by the calculation of T×50%, and then a length Tk of the lower half of the passenger's body within a range which may provide a easy egress move of the passenger after the driver's head moving out of the door opening, that is, a length Tk of the lower half of the body which influences the burden to the lower half of the passenger's body is calculated using the coefficient (65-85%, for example) stored in the memory portion 35. Herein, a greater value may be appropriate at the passenger egresses from the vehicle, so a value of 85%, for example, may be used for the calculation. Herein, the above-described range providing the easy egress move of the passenger after the driver's head moving out of the door opening is the one in which a value which is obtained by multiplication of a torque applied to a joint of the ankle, a torque applied to a joint of the knee, and a torque applied to a joint of the crotch on a locus of the driver's move after the driver's head moving out of the door opening through a simulation becomes the minimum.

The height Hs of the seat's sitting face which ensures this calculated length Tk of the lower half of the body which influences the burden to the lower half of the passenger's body is calculated, and this calculated height Hs is reduced by the corrective value corresponding to the angle of the door opening, so that the preferable height H1 of the seat's sitting face for the egress move of the passenger after the driver's head moving out of the door opening is obtained finally.

Thus, by correcting the heights H1, H2 of sitting face of the seat in accordance with the opening angle of the door, the burden to the passenger can be reduce considering that the gravity center of the passenger's body at the passenger's egress changes in accordance with the opening angle of the door.

Particularly, while the vehicle according to the present embodiment is a type of vehicle in which the upper edge of the door opening of the door becomes shorter gradually along the rearward direction of the vehicle, at least one of the heights H1, H2 of sitting face of the rear seat 10r is corrected in such a manner that the height corrected becomes lower when the opening angle of the rear door is relatively small. Thereby, even in case the opening angle of the rear side door is so small that the gravity center of the passenger's body moves rearward and the passenger need to egress through an area in which the upper edge of the door opening becomes relatively low, the height Hs of the sitting face of the seat is lowered correctively, so that the passenger's head can be properly passed below the upper edge of the door opening with little burden to the passenger.

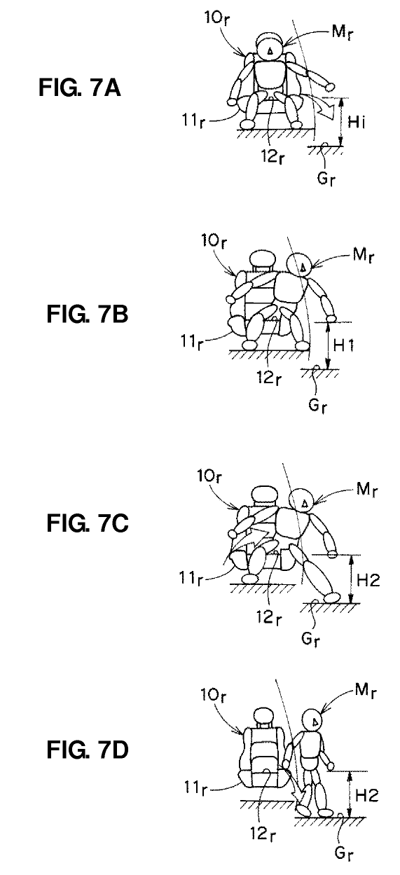

FIGS. 7A through 7D are explanatory diagrams schematically showing a sequence of an egress move of the passenger Mr seated in the rear seat 10r. The rear seat 10r which has the original height H1 shown in FIG. 7A is adjusted to the height H1 until the completion of the passenger's head moving out of the door opening (see FIGS. 7B and 7C). Then, after the completion of the passenger's head moving out, it is adjusted to the height H2 (see FIG. 7D).

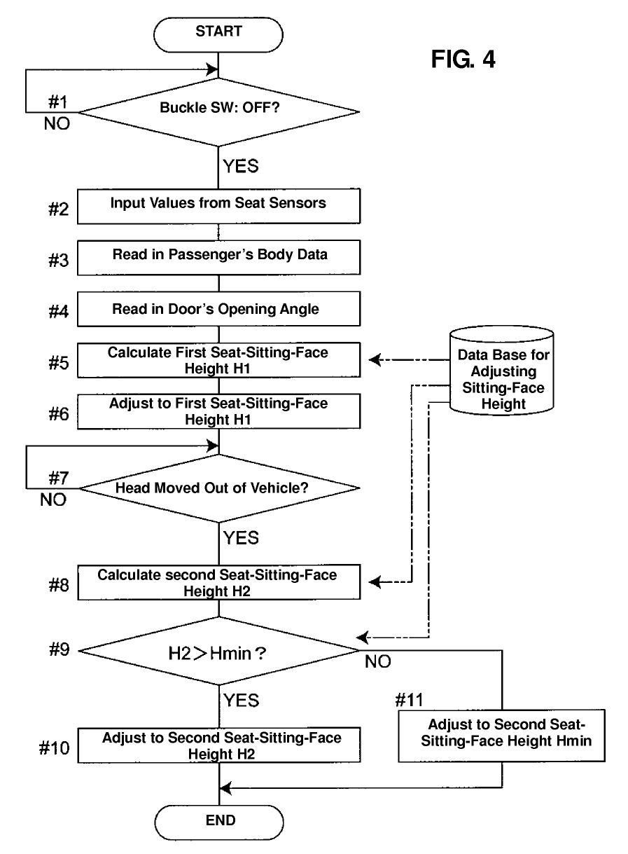

An operation control of the seat 10f, 10r at the passenger's egress from the vehicle will be described as an example for the rear seat 10r. FIG. 4 is a flowchart explaining the operation control of the rear seat 10r at the passenger's egress. After the system starts, in step #1, it is determined based on a state of ON/OFF of the buckle SW 22 whether the passenger Mr starts the egress move or not. Herein, the present system starts with its initial state in which the passenger Mr is seated in the seat 10r and the seatbelt buckle is locked with the buckle SW 22 on. Accordingly, when the buckle SW 22 is turned off from its ON state (YES: in the step #1), it is determined that the passenger Mr starts the egress move. Meanwhile, the ON state of the buckle SW 22 is maintained (NO: in the step #1), it can be determined that the passenger Mr has no intention of the egress.

When it is determined that the passenger Mr starts the egress move (YES: in the step #1), the detecting value of the seat vertical position sensor 21r, the data of the passenger's body size, and the opening angle of the door are read in respectively in steps #2, #3 and #4. The data of the passenger's body size and the opening angle of the door are based on the data of the image picked up by the camera 9, for example.

In the next step #5, the first seat-sitting-face height H1 as the preferable height of the seat's sitting face for the egress move of the passenger during the time from the egress start of the vehicle to the completion of the driver's head moving out of the door opening K is calculated based on the passenger's body-size data, the roof height Ht of the vehicle, and the opening angle of the door and by using the data for adjusting the sitting-face height. Then, in step #6, the height Hs of the sitting face of the rear seat is adjusted to the first seat-sitting-face height H1 in accordance with the above-described calculation results.

The first seat-sitting-face height H1 until the completion of the driver's head moving out of the door opening K is calculated based on the length Tj of the upper half of the passenger's body which influences the burden to the upper half of the body of the passenger Mr as described above. Accordingly, the burden to upper half of the passenger's body for taking the position with the stoop can be reduced properly, ensuring the enough head clearance until the passenger's head moving out of the vehicle.

In the next step #7, it is determined based on the image data picked up by the camera 9 whether the passenger's head has moved out of the door opening K or not. When the determination result is YES, the second seat-sitting-face height H2 as the preferable height of the seat's sitting face after the driver's head has moved out of the door opening K is calculated in step #8. The calculation of the second seat-sitting-face height H2 is conducted based on the passenger's body-size data, the floor height Hu of the vehicle, and the opening angle of the door and by using the data for adjusting the sitting-face height.

Then, it is determined whether the second seat-sitting-face height H2 calculated in the step #8 is greater than the above-described minimum height Hmin or not (step #9). This minimum height Hmin is the one to ensure the necessary minimum distance Lmin between the hip point HP of the rear seat 10r and the tire house 7 as described above, and the height Hs of the sitting face of the rear seat should not be set to be smaller than this minimum height Hmin regardless of what the second seat-sitting-face height H2 calculated in the step #8 is.

Accordingly, when the determination result in the step #9 is YES (H2>Hmin), the sitting-face height Hs of the rear seat 10r is adjusted to the above-described second sitting-face height H2 (step #10). When the determination result in the step #9 is NO, the seat-sitting-face minimum height Hmin is adjusted to the second sitting-face height H2 and then the sitting-face height Hs of the rear seat 10r is adjusted to the second sitting-face height H2 (=Hmin) (step #11).

Since the above-described second sitting-face height H2 after the passenger's head moving out of the door opening is determined based on the length Tk of the lower half of the passenger's body which influence the burden to the lower half of the body as described above, the muscle burden of the lower half of body of the passenger Mr after the passenger's head has moved out of the vehicle. Further, since the second sitting-face height H2 after the passenger's head moving out of the door opening K is greater than the minimum height Hmin of the seat's sitting face which is necessary to ensure the necessary minimum distance Lmin between the rear seat 10r and the tire house 7, the burden to avoid the interference of the passenger's hip with the tire house at the vehicle egress is reduced effectively.

As described above, according to the present embodiment, the height of the sitting face of the seat is adjusted to the first height H1 during the time from the start of egress of the passenger to the completion of the driver's head moving out of the door opening K, and the height is adjusted to the second height H2 after the completion of the driver's head moving out of the door opening K. Thereby, since the height of the seat sitting face is properly adjusted respectively before and after the driver's head moves out of the door opening during the egress move of the passenger in accordance with the change of the burden to the upper half and the lower half of the passenger, the burden to the passenger at the passenger's egress can be reduced effectively.

Herein, the above-described matters which are explained for the rear seat 10r are applicable to the front seat 10f basically except the contents which are influenced by the relationships between the rear tire house 7 and the seat 10r.

While the seat-sitting-face heights H1, H2 are obtained by the calculations of a calculation circuit (the height calculating portions 36, 37) of the seat control unit 30, these may be obtained by reading out from memory data which are stored in the memory in accordance with the kinds of the passenger's body size.

The present invention should not be limited to the above-described embodiments, and any other modifications and improvements may be applied in the scope of a sprit of the present invention.

What is claimed is:

1. A seat device for a vehicle, comprising:
an egress-start determining device to determine a start of egress of a passenger seated in a seat of the vehicle;
a completion determining device to determine completion of a driver's head moving out of a door opening of the vehicle after the start of egress of the passenger; and
a seat-sitting-face height adjusting device to adjust a height of a sitting face of the seat in such a manner that the height is adjusted to a first height during a time from the start of egress of the passenger to the completion of the driver's head moving out of the door opening of the vehicle, and the height is adjusted to a second height after the completion of the driver's head moving out of the door opening of the vehicle.

2. The seat device for a vehicle of claim 1, further comprising a body-size detecting device to detect a body size of the passenger, wherein said first height is set based on a length of an upper half of a passenger's body which influences a burden to the upper half of the passenger's body and said second height is set based on a length of a lower half of the passenger's body which influences a burden to the lower half of the passenger's body.

3. The seat device for a vehicle of claim 2, further comprising a door-opening angle detecting device to detect an opening angle of a door, wherein at least one of said first height and second height is corrected by the opening angle of the door which is detected by the door-opening angle detecting device.

4. The seat device for a vehicle of claim 3, wherein the vehicle is a type of vehicle in which an upper edge of a door opening of a rear side door becomes shorter gradually along a rearward direction of the vehicle, said seat-sitting-face height adjusting device is applied to a rear seat which is provided beside the rear side door, and at least one of said first height and second height is corrected by the opening angle of the rear side door which is detected by the door-opening angle detecting device in such a manner that the height corrected becomes lower when the opening angle of the rear side door is relatively small.

5. The seat device for a vehicle of claim 3, wherein said seat is a rear seat of the vehicle, and said second height is greater than a tire house which is provided substantially beside the rear seat.

6. The seat device for a vehicle of claim 1, wherein said completion determining device comprises an image picking-up device which is provided at a door mirror of the vehicle.

7. The seat device for a vehicle of claim 2, wherein said body-size detecting device comprises an image picking-up device which is provided at a door mirror of the vehicle.

8. The seat device for a vehicle of claim 1, wherein said second height is greater than said first height.
